(19) United States
(12) Patent Application Publication
(10) Pub. No.: US 2024/0075896 A1
(43) Pub. Date: Mar. 7, 2024

(54) METHOD AND DEVICE FOR PERSONALIZED ACTIVE SAFETY CONTROL

(71) Applicants: Hyundai Motor Company, Seoul (KR); Kia Corporation, Seoul (KR)

(72) Inventors: Ji Hoon Oh, Uiwang (KR); Dong Min Shin, Seoul (KR); Un Chin Park, Seoul (KR); Il Sang Kim, Hwaseong (KR)

(21) Appl. No.: 17/983,737

(22) Filed: Nov. 9, 2022

(30) Foreign Application Priority Data
Sep. 7, 2022 (KR) 10-2022-0113448

(51) Int. Cl. B60R 21/0134; B60R 21/015

(52) U.S. Cl. CPC B60R 21/0134; B60R 21/01558; B60R 2021/01317

(57) ABSTRACT

Disclosed herein method and device for personalized active safety control. The method includes: generating input data including body information of a vehicle occupant and occupancy state information of the occupant; outputting initial control data of a restraint device of a vehicle based on collision data that responds to occurrence of a collision of the vehicle; producing injury risk information for each piece of adjustment restraint information by using a safety control model based on the adjustment restraint information, in which a variable adjustment parameter is applied to the initial control data, and the input data; generating, by the safety control model, optimal restraint control information among the adjustment restraint information, based on the injury risk information; and controlling the restraint device based on the optimal restraint control information.

### CROSS REFERENCE TO RELATED APPLICATION

The present application claims under 35 U.S.C. § 119(a) priority to Korean application 10-2022-0113448, filed Sep. 7, 2022, the entire contents of which are incorporated herein for all purposes by this reference.

### BACKGROUND

### Field of the Disclosure

The present disclosure relates to a method and device for personalized active safety control and, more particularly, to a personalized active safety control method and device that actively restrain an occupant in an optimal manner according to the occupant's body profile and a real-time occupancy state and thus enhance safety function in case of a collision accident of a vehicle.

### Background

When a collision accident of a vehicle occurs, an occupant can be protected by a restraint device that is applied to the vehicle. A restraint device may be a device that is installed in a vehicle for the purpose of reducing the injury of an occupant caused by a collision. For example, the restraint device may be a seat belt, an airbag, a seat with adjustable inclination, a steering column based on steering, and many other interior components. Usually, the seat belt, the airbag and the seat with adjustable inclination may be restraint devices that can control an impact energy onto an occupant most effectively.

The seat belt and the airbag may be designed and verified so as to be optimized according to the legal regulations and marketability evaluation items of each country. Herein, a test dummy imitating an occupant represents the body type and weight set up for the men or the women, and the sitting location of the occupant is also set to one defined for test. That is, a type of dummy and a sitting location are standardized, and the safety of occupants is verified only in a limitedly standardized situation.

However, no optimal control technology has been commercialized which considers various collision modes in an actual driving situation, various body features (e.g., body type and weight) of occupants apart from dummy, and a sitting location. There is a conventional technology of fastening a seat belt in advance by recognizing a collision situation beforehand, but this technology determines the restraint force of a seat belt by using only control data that is determined according to crash test results for standardized dummies. Consequently, there are limitations in ensuring the optimal safety of occupants in various collision situations that occur in actual driving. In this regard, there is practical difficulty with performance verification for each scenario type by establishing scenarios considering all the various situations.

Accordingly, in order to provide optimized collision safety to occupants, it is necessary to provide a method of actively controlling the performance factors of a restraint device by determining damage risk during a collision according to an occupant's body features and an occupancy situation.

### SUMMARY

The present disclosure is technically directed to provide a personalized active safety control method and corresponding device that actively restrain an occupant in an optimal manner according to the occupant's body profile and a real-time occupancy state and thus enhance safety function in case of a collision accident of a vehicle.

The technical objects of the present disclosure are not limited to the above-mentioned technical objects, and other technical objects that are not mentioned will be clearly understood by those skilled in the art through the following descriptions.

According to the embodiment of the present disclosure, there is provided a method for personalized active safety control, the method comprising: generating input data including body information of an occupant of a vehicle and occupancy state information of the occupant; outputting initial control data of a restraint device of the vehicle based on collision data in response to a collision of the vehicle; producing injury risk information for each piece of adjustment restraint information by using a safety control model based on the adjustment restraint information, wherein a variable adjustment parameter is applied to the initial control data, and the input data; generating, by the safety control model, optimal restraint control information from among the adjustment restraint information, based on the injury risk information; and controlling the restraint device based on the optimal restraint control information.

According to the embodiment of the present disclosure in the method, the input data may include the body information, the occupancy state information and the collision data, and wherein the safety control model may be established as a model that is learned to: (a) produce part injury data for each body part of an occupant based on the input data and the adjustment restraint information, and (b) generate an estimated injury degree based on the part injury data.

According to the embodiment of the present disclosure in the method, the estimated injury degree may be generated by adjusting a basic estimated injury degree based on the part injury data, and the basic estimated injury degree may be set in advance based on the collision data and the body information.

According to the embodiment of the present disclosure in the method, the body information may include the occupant's age, height, weight, and sex, and the basic estimated injury degree is individually set according to a section of the age.

According to the embodiment of the present disclosure in the method, the collision data may be converted into general collision data that is input to the initial control data.

According to the embodiment of the present disclosure in the method, the generating of the input data step may further comprise estimating the detailed body information that is not received, based on data obtained through a camera of an occupant monitoring module and an occupant information estimation module of the vehicle, if at least a portion of the detailed body information constituting the body information is not received as an input of the occupant, and generating the body information by using the estimated detailed body information.

According to the embodiment of the present disclosure in the method, the occupancy state information may include the occupant's sitting posture in a seat and a relative spacing state between the occupant's body part and an interior part of the vehicle.

According to the embodiment of the present disclosure in the method, the occupancy state information may be generated based on image data that is obtained from a camera of an occupant monitoring module installed in the vehicle.

According to the embodiment of the present disclosure in the method, the sitting posture of the occupant may be estimated based on the body condition.

According to the embodiment of the present disclosure in the method, the method may further comprise: setting the injury risk information associated with the optimal restraint control information as personalized injury risk information; notifying, externally, the injury risk information in response to satisfaction of a predetermined condition; receiving medical data caused by external treatment of an injured occupant; and recalculating the injury risk information based on the medical data and updating the safety control model.

According to another aspect of the present disclosure, there is provided a device for personalized active safety control, the device comprising: a memory storage configured to manage a learning model; and a processor configured to process active safety control by using a safety control model according to the learning model. The processor is further configured to: generate input data including body information of an occupant of the vehicle and occupancy state information of the occupant, output initial control data of a restraint device of the vehicle based on collision data in response to a collision of the vehicle, produce injury risk information for each piece of adjustment restraint information by using the safety control model based on the adjustment restraint information, wherein a variable adjustment parameter is applied to the initial control data and the input data; generate, by the safety control model, optimal restraint control information from among the adjustment restraint information, based on the injury risk information, and control the restraint device based on the optimal restraint control information.

The features briefly summarized above for this disclosure are only exemplary aspects of the detailed description of the disclosure which follow, and are not intended to limit the scope of the disclosure.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

### BRIEF DESCRIPTION OF THE DRAWINGS

FIG. 1 is a block diagram for a personalized active safety control device according to an embodiment of the present disclosure.

FIG. 2 is a flowchart for a personalized active safety control method according to another embodiment of the present disclosure.

FIG. 3A and FIG. 3B are views exemplifying a process of generating optimal restraint control information in a safety control model.

FIG. 4 is a view exemplifying a safety control model.

FIG. 5 is a view exemplifying a basic estimated injury degree.

### DETAILED DESCRIPTION OF THE DISCLOSURE

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present disclosure and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B and C”, “ ” at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described with reference to the accompanying drawings.

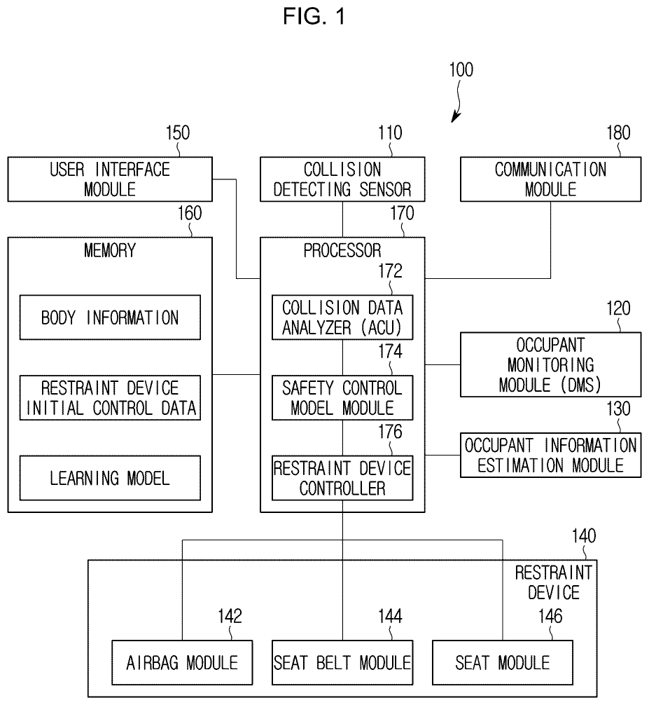

Hereinafter, referring to FIG. 1, a personalized active safety control device will be described in accordance with an embodiment of the present disclosure.

FIG. 1 is a block diagram for a personalized active safety control device according to an embodiment of the present disclosure.

A personalized active safety control device 100 may be a device that optimizes the control of a restraint device 140 to minimize the injury of an occupant in a vehicle in a vehicle collision situation. For example, a vehicle may refer to a moving object capable of moving to a specific place. The moving object may be a normal vehicle, a mobile office, or a mobile hotel. The normal vehicle may be a four-wheel car, for example, a sedan, a sports utility vehicle (SUV), and a truck. In the present disclosure, the description mainly focuses on a ground-moving object, but the device 100 may be applied to an aerial moving object in some cases. For example, the aerial moving object may be a drone or a personal aerial vehicle (PAV). The moving object 100 may be realized by manned driving or autonomous driving (either semi-autonomous or full-autonomous driving).

The device 100, which is operated in a vehicle, may specifically include a collision detection sensor 110, an occupant monitoring module (driver monitoring module) 120, an occupant information estimation module 130, a restraint device 140, a user interface module 150, a memory 160, a processor 170, and a communication module 180.

The collision detection sensor 110 may be provided as various sensors that detect a collision between a vehicle and an external object or an expected collision situation and generate collision data. For example, the collision data may be an impulse, a collision deceleration (or vehicle deceleration), a type of bump on an external object, a distance of approach to a collision object, and a change of speed between before and after collision. As an example, the collision detection sensor 110 may be configured as a single sensor module or a multiple sensor module. As an example, the single sensor module may be a head-on and broadside collision detection sensor, and this collision detection sensor may be a type of accelerometer or a type of pressure. Apart from the sensors, the single sensor module may be an accelerometer sensor, a distance sensor and the like. The single sensor module, which is configured as the above-described example, may output each measurement value, and collision data may be calculated based on measurement values. As an example, the multiple sensor module may configure the above-listed sensors in a single casing and synchronize and output measurement values.

The occupant monitoring module 120 may obtain data associated with the occupancy state of all occupants inside a vehicle. As an example, the occupant monitoring module 120 may have a camera capable of capturing an occupancy location, the body parts of most occupants, and an interior part around an occupant. As an example, the occupant monitoring module 120 may obtain image data associated with a sitting posture of each occupant by using a camera. As an example, the sitting posture may be the inclination and shape of each occupant's upper body, a head position, a bending shape of neck, and the posture of lower body and leg. In addition, image data associated with a sitting posture may include an image showing a relative spacing state between an occupant's body part and a neighboring interior part. As an example, an interior part may be a steering wheel, a window, a ceiling, a door, and an accessory component. In addition, the occupant monitoring module 120 may capture a face and a body in order to obtain image data for estimating detailed body information of body information like an occupant's age, sex, height and body shape.

The occupant information estimation module 130 may be a sensing module that obtains sensing data for estimating body information of an occupant. As an example, the occupant information estimation module 130 may be a weight detection sensor installed in a seat and a biometric sensor capable of obtaining an occupant's biosignal. In the case of a weight detection sensor, an occupant's weight may be estimated which is detected as the occupant sits on a seat. As an example, a biometric sensor may be installed in a steering wheel grasped by a driver and in a predetermined part of an arm rest at a passenger side. A biometric sensor is not limited to the above-described example and may be installed in parts of various modules. A biometric sensor may measure a driver or a passenger's pulse, blood pressure, electrocardiogram and the like. As another example, a biometric sensor may be an image acquisition module that checks an occupant's pupil, gaze and face condition. Herein, a biometric sensor may detect dilation or contraction of a pupil, gaze movement, eye blinking, change of face color, and a change in an occupant's fatigue.

The restraint device 140 may be a hardware component for minimizing an occupant's injury in a vehicle collision or an expected collision situation. The restraint device 140 may control the restraint of an occupant according to optimal restraint control information delivered from the processor 170. The restraint device 140 may be installed for each occupant and process restraint control according to optimal restraint control information optimized for each occupant. As an example, the restraint device 140 may be an airbag module 142, a seat belt module 144, and a seat module 146 that is inclinable and rotary. The airbag module 142 may have an actuator and a software component that control the deployment time and deployment direction of an airbag according to optimal restraint control information. The seat belt module 144 may have an actuator and a software component that control the tension application time and restraint load of a belt according to optimal restraint control information. The seat module 146 may have an actuator and a software component that control a buffer slope during shaking of a seat, which minimizes impulse from collision, a suitable standing angle of the seat, and a rotation angle of the seat according to optimal restraint control information.

The user interface module 150 may be a module for implementing an input for executing, by an occupant, a vehicle function and an output for providing various states of the vehicle and a surrounding situation. As an example, the user interface module 150 may be a touch input-type display, which is an infotainment screen. In addition, the user interface module 150 may be provided to identify data, which an occupant's user device inputs through the communication module 180, and show processing of a request of the user device as a response form. As an example, an occupant in a vehicle may input his/her body information through the user interface module 150 or a user device. As an example, the body information may include detailed body information like an occupant's age, sex, height and weight. The body information thus input may be continuously stored by the memory 160, and an occupant may call his/her body information to the processor 170 through an identification and authentication process with a vehicle.

The memory 160 may store and manage input and output data that is used for vehicle control and various software for controlling a vehicle. As for data utilized in the active safety control device 100, the memory 160 may manage each occupant's body information using a vehicle, initial control data of the restraint device 140, and a pretrained learning model for active safety control.

Initial control data may be initial restraint control data for the restraint device 140 based on collision data that is generated from the occurrence of collision of a vehicle. As an example, initial control data may be basic restraint control data for minimizing injury based on collision deceleration that is discretely set in a standardized dummy and a simulation test. Initial control data may be set as default data, irrespective of the body information and occupancy state of a current occupant.

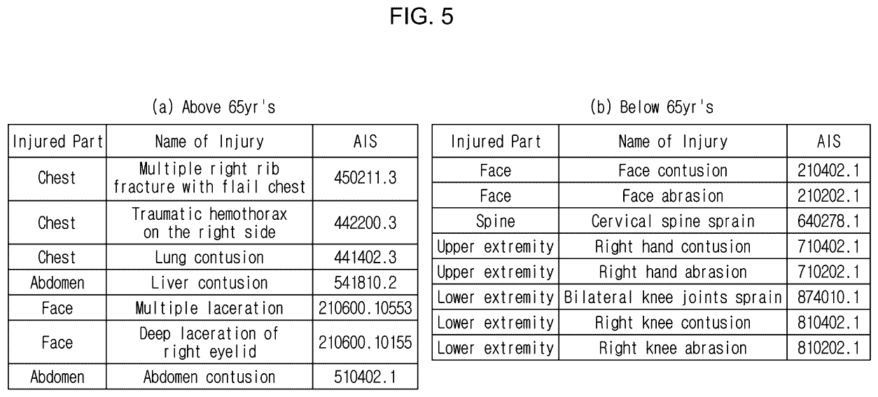

A learning model may be a safety control model that is pretrained to produce injury data for each body part of an occupant based on collision data, body information and occupancy state data and to generate an estimated injury degree based on injury data of body part. In addition, a learning model may be trained beforehand to generate an estimated injury degree in a collision situation based on adjustment restraint information, which varies by applying a variable adjustment parameter to initial control data, and the above-described data. Herein, the above-described data may include at least one of body information, data about an occupancy state, collision data (or general collision data), body part injury data, and an estimated injury degree. An estimated injury degree may be generated by adjusting a basic estimated injury degree based on body part injury data. A basic estimated injury degree may be set in advance based on collision data and body information and be managed in the memory 160. As exemplified in FIG. 5, a basic estimated injury degree may be individually set according to an age section in body information.

In addition, a learning model may include an analysis algorithm that generates optimal restraint control information by analyzing an estimated injury degree according to each adjustment restraint information. A learning model may be implemented in a collision situation by being loaded onto a safety control model module 174 of the processor 170. In the present disclosure, for convenience of explanation, a learning model is described interchangeably with a safety control model loaded onto the processor 170. As an example, a learning model may be a transferable self-attentive representation learning based deep neural network model (TSRnet).

The processor 170 may receive the body information of each occupant that is input through the user interface module 150 or a user device. When at least some of detailed body information of body information is not received as an occupant's input, the processor 170 may estimate the detailed body information not received based on data that is obtained through a camera of the occupant monitoring module 120 and the occupant information estimation module 130 that are installed in a vehicle. The processor 170 may generate body information from the estimated detailed body information.

Based on image data obtained from a camera of the occupant monitoring module 120, the processor 170 may generate occupancy state information. When no sitting posture is identified from image data associated with occupancy state, the processor 170 may estimate an occupant's unidentified sitting posture based on body information including age, sex, height and body type. Based on the estimated sitting posture, the processor 170 may generate the occupant's occupancy state information. For example, in the case of an aged occupant over 65, the occupant may tend to sit about 60 mm leaning forwards as compared with those below 65. Accordingly, when the sitting posture of an occupant, who is identified to be aged, is not obtained from image data, occupancy state information may have a plurality of datasets generated based on the leaning-forward sitting posture described above. As an example, the plurality of datasets may be data associated with the inclination and shape of the occupant's upper body, a head position, a bending shape of neck, and the posture of lower body and leg. In addition, the data may include data associated with an average relative spacing state between the occupant's body part and an adjacent interior part.

The processor 170 may generate optimal restraint control information for each occupant and also generate personalized injury risk information for each occupant, by using collision data, body information, occupant state-related data, occupant information-related sensing data, and a loaded learning model.

Specifically, the processor 170 may include a collision data analyzer 172, a safety control model module 174, and a restraint device controller 176.

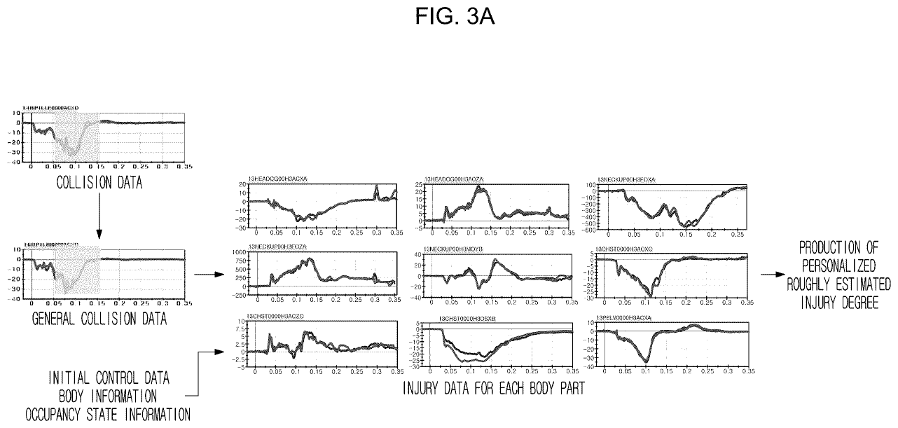

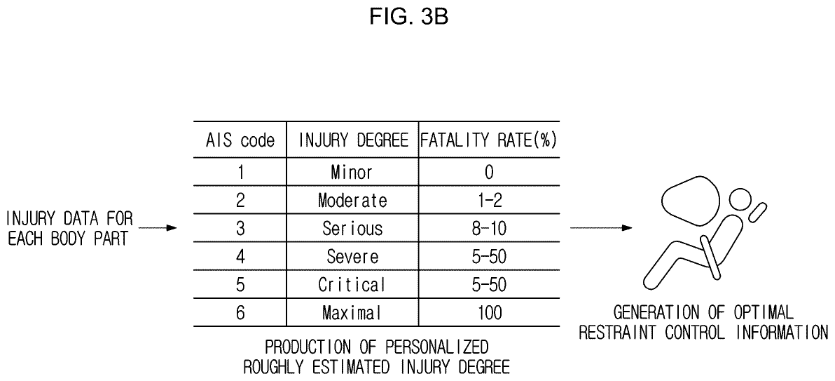

The collision data analyzer 172 may analyze actual collision data obtained from the collision detection sensor 110 and match general collision data for outputting initial control data. That is, collision data may be converted to general collision data. As an example, general collision data may be standardized collision data that is generated beforehand by learning and analyzing actual collision data of the memory 160 through a learning model like TSRnet. Standardized collision data may be prepared each of multiple values that constitute actual collision data. Actual collision data obtained from the collision detection sensor 110 and general collision data may be represented as exemplified in FIG. 3A. As an example, the collision data analyzer 172 may be implemented in an airbag control unit.

The safety control model module 174 may call and load a learning model from the memory 160 in a collision situation and generate injury risk information of each occupant by using a learning model that receives the above-described information and data as input. The information and data may include at least one of body information, occupancy state information, collision data (or general collision data), body part injury data, and an estimated injury degree. Specifically, the injury risk information may be calculated for each piece of adjustment restraint information based on adjustment restraint information, which applies a variable adjustment parameter to initial control data, and input data. Input data may include at least each occupant's body information and occupancy state information. The safety control model module 174 may generate each occupant's optimal restraint control information based on injury risk information.

The safety control model module 174 may externally notify an occupant's injury risk information in response to satisfaction of a predetermined condition. The predetermined condition may be a value according to injury risk information equal to or greater than a reference level or the evacuation of at least one occupant to a medical institution. Specifically, as an example, the predetermined condition may be a case in which injury risk information is determined to be serious injury according to MS level, or a case in which an accident to an occupant or outsider is reported and the occupant is evacuated to a medical institution.

In addition, after the occupant is treated, the safety control model module 174 may receive medical data due to the treatment of the injured occupant from the server of the medical institution and update injury risk information and a safety control model according to actual injury information.

The restraint device controller 176 may instruct to individually control the airbag module 142, the seat belt module 144 and the seat module 146 that are provided to each occupant according to the optimal restraint control information of each occupant.

The communication module 180 may support communication with an occupant's user device inside a vehicle or communication with an external device. The external device may be another vehicle around the vehicle, a roadside unit (RSU), a server of an external organization, and the like. As an example, the communication module 180 may support Bluetooth, infrared communication, C-V2X or WAVE(DSRC) for V2X, LTE, and 5G communication.

FIG. 1 exemplifies that a learning module embedded in the memory 160 and the safety control model module 174 of the processor 170 generate optimal restraint control information and injury risk information. In another example, body information, occupancy state information and collision data may be generated in a vehicle, and optimal restraint control information and injury risk information may be generated by an external system that perform overall management of an external server or vehicle communicating with the vehicle.

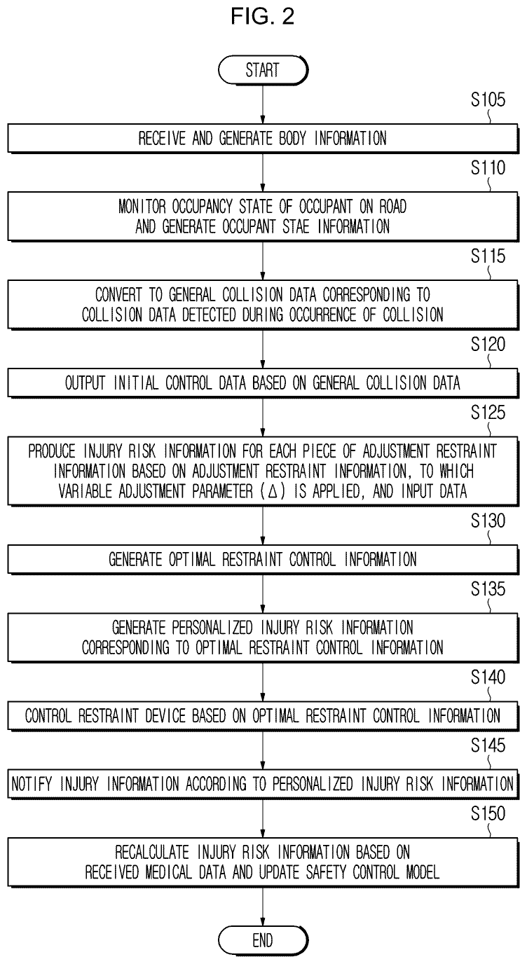

Hereinafter, referring to FIG. 2 to FIG. 5, a personalized active safety control method will be described. FIG. 2 is a flowchart for a personalized active safety control method according to another embodiment of the present disclosure. FIG. 2 is described mainly based on a vehicle according to the disclosure of FIG. 1, but the method of FIG. 2 may also be applied to a case in which optimal restraint control information and injury risk information are generated by an external server.

First, an occupant of a vehicle inputs his/her body information through the user interface module 150 or a user device, and the processor 170 may store the input body information in the memory 160 (S105).

The body information may include detailed body information like the occupant's age, height, weight and sex. Unlike the above-described embodiment, when the occupant does not input at least some of the detailed body information listed above, a camera of the occupant monitoring module 120 and the occupant information estimation module 130 may obtain and deliver image data and relevant sensing data to the processor 170. Based on the delivered data, the processor 170 may estimate detailed body information, which is not input, and generate body information from the estimated detailed body information.

For example, when the occupant does not detailed body information on age, height and sex, the processor 170 may confirm that an image of the occupant taken by the camera is not stored in the memory 160, and then analyze the image of the occupant that is not stored. Through the image analysis, the processor 170 may estimate the occupant's age, height, sex and body type. In addition, when the occupant does not input weight, the processor 170 may obtain weight data from a weight detection sensor of a seat, which constitutes the occupant information estimation module 130, and estimate the occupant's weight based on the obtained data.

Next, the occupant monitoring module 120 may transmit image data associated with the occupant's occupancy state while driving to the processor 170 by a camera, for example, and the processor 170 may generate occupancy state information in real time based on the image data (S110).

For example, the occupancy state information may include an occupancy location, the occupant's sitting posture in a seat and a relative spacing state between the occupant's body part and an interior part of the vehicle. For example, the space may be a space between the occupant's head and a windshield/side window, a space between the occupant's chest and a steering wheel, a space between the occupant's chest and a front part (e.g., globe box, front seat), a space between the occupant's knee and an interior part of the vehicle, and the like. The sitting posture may be estimated based on image data or be estimated based on body information in another example. For example, when the occupant is an elderly person aged over 65, the processor 170 may consider a tendency of setting about 60 mm leaning forwards as compared with those below 65 and estimate the sitting posture reflecting the tendency.

Next, when the collision detection sensor 110 detects a collision between the vehicle and another object, the collision detection sensor 110 may obtain and transmit collision data to the processor 170, and the collision data analyzer 172 may perform conversion to general collision data corresponding to the collision data (S115).

FIG. 3A and FIG. 3B are views exemplifying a process of generating optimal restraint control information in a safety control model. As exemplified in FIG. 3A and FIG. 3B, the collision data analyzer 172 may not only analyze collision data but also retrieve general collision data stored in the memory 160, thereby selecting general collision data close to the collision data. FIG. 3A exemplifies collision data and general collision data with overlapping values obtained from each of a plurality of sensors.

Next, based on the general collision data, the processor 170 may call and output initial control data of the restraint device 140 from the memory 160 (S120).

The initial control data may be set as default data, irrespective of body information and occupancy state for current occupants and may be initial restraint control data in the airbag module 142, the seat belt module 144 and the seat module 146 that are uniquely set for each seat. As an example, initial restraint control data of the airbag module 142 may be data set by default in association with a deployment time and a deployment direction of the airbag module 142. In the case of the seat belt module 144, as an example, initial restraint control data may be control data set by default in association with a tension application time and a restraint load of a seat belt. In the case of the seat module 146, as an example, initial restraint control data may be data set by default in association with a buffer slope during shaking of a seat, a suitable standing angle of the seat, and a rotation angle of the seat. Initial restraint control data may be different according to each vehicle type and each seat but may be set to be identical in a same seat.

Next, the processor 170 may call a learning model to the safety control model module 174, and the safety control model module 174 may calculate injury risk information for each adjustment restraint information based on adjustment restraint information, which applies a variable adjustment parameter to the initial control data, and input data (S125).

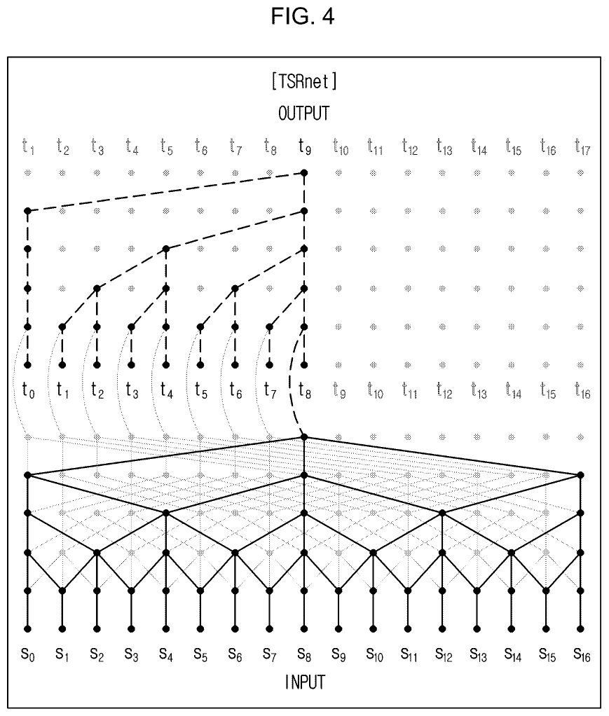

Herein, the input data may include body information, occupancy state information and general collision data. As exemplified in FIG. 3A and FIG. 3B, by using a TSRnet model exemplified in FIG. 4, the safety control model module 174 may produce part injury data for each body part of each occupant based on input and adjustment restraint information and generate an estimated injury degree of each occupant based on the part injury data. As an example, the TSRnet model of FIG. 4 may employ input data of each occupant, initial control data, adjustment restraint information, and a basic estimated injury degree of each occupant, which will be described below, as input values. Part injury data may be output as intermediate data by a TSRnet model that is trained in association with input data and adjustment restraint information. Part injury data may be exemplified as injury data of each body part in FIG. 3A. FIG. 3A exemplifies part injury data with division into head, neck, and chest. As a weight model, which is already learned with immediate data, is applied to a basic estimated injury degree, a basic estimated injury degree with a weight being applied to it may be output as an estimated injury degree, that is, a final output value. Like an output value exemplified in FIG. 4, an estimated injury degree may be generated for each body part of each occupant, and an AIS score or level may be assigned to each body part. As another example, an estimated injury degree may be produced for body parts that are subject to major injuries. As yet another example, as exemplified in FIG. 3B, an estimated injury degree may be produced as a single code and level showing a rough injury level throughout the body. As yet another example, an estimated injury degree may be determined by a combination of at least two of the above-described examples.

A variable adjustment parameter may be a difference value from detailed restraint control data of a restraint device in a permissible range. The safety control model module 174 may generate adjustment restraint information by changing a variable adjustment parameter at a predetermined interval within the difference value and repeatedly produce injury risk information based on each adjustment restraint information.

An estimated injury degree may be generated by adjusting a basic estimated injury degree based on body part injury data, and a basic estimated injury degree may be set in advance based on collision data and body information. As an example, a basic estimated injury degree may be individually set according to sections of age.

FIG. 5 is a view exemplifying a basic estimated injury degree. As in the example of FIG. 5, a basic estimated injury degree of an elderly person aged over 65 and a basic estimated injury degree of a normal person aged under 65 show different body part injuries and severity levels even when the same collision data and deceleration are given. The basic estimated injury degrees according to each age in FIG. 5 are based on standardized collision data and body information. In addition, as an example, a basic estimated injury degree of a normal person may be classified as serious damage equivalent to ISS 15 or above in the Injury Severity Score (ISS) system using the Abbreviated Injury Scale (AIS) as an optimal injury criterion. However, a basic estimated injury degree of an elderly person may use the Maximum Abbreviated Injury Scale (MATS) and the Injury Severity Score (ISS) as optimal injury criteria. As an AIS level of the basic estimated injury degree of an elderly person increases by 0.25 as compared with that of a normal person, it may be set to ISS 10 not to ISS 15, which a criterion for a severe injury. In addition, FIG. 5 shows that injury parts with high AIS level are different according to each age. For example, an elderly person aged over 65 may have a higher chest injury level than a normal person, when the same collision data is given. Even in case of a light collision, according to the restraint control of the seat belt module 144 and the airbag module 142, an elderly person may be more subject to a fatal chest injury than a normal person. Accordingly, optimal restraint control information suitable for the age of an occupant needs to be generated.

In addition, even when basic estimated injury degrees for each age group are set, they may not be suitable according to an occupant's actual age, height, weight, occupancy state during collision, and restraint control information to be actually applied. Accordingly, the safety control model module 174 may produce a personalized estimated injury degree for an occupant by adjusting a basic estimated injury degree based on part injury data.

Next, based on each occupant's injury risk information, the safety control model module 174 may generate and deliver optimal restraint control information from adjustment restraint information to the restraint device controller 176 (S130).

As an example, the safety control model module 174 may employ adjustment restraint information, which minimizes injury risk information, as optimal restraint control information. For example, optimal restraint control information may be airbag control data associated with the deployment time and deployment direction of the airbag module 142. In the case of the seat belt module 144, as an example, optimal restraint control information may be belt control data associated with a tension application time and a restraint load of a seat belt. In the case of the seat module 146, as an example, optimal restraint control information may be seat control data associated with a buffer slope during shaking of a seat, a suitable standing angle of the seat, and a rotation angle of the seat.

Next, the safety control model module 174 may employ injury risk information, which is utilized to generate the optimal restraint control information, as personalized injury risk information of a corresponding occupant (S135).

Next, the restraint device controller 176 may control the restraint device 140 applied to the occupant based on the optimal restraint control information of each occupant (S140). The optimal restraint control information may be generated by being personalized based on each occupant's information, for example, body information, occupancy state information, occupancy location, and vehicle deceleration. As an example, an actual injury level of an aged occupant may be reduced because of a lower restraint load than that of a normal person seated on a rear seat, and an airbag deployment direction and deployment time different from those of a normal person.

Next, the safety control model module 174 may externally notify an occupant's personalized injury risk information in response to satisfaction of a predetermined condition (S145).

The predetermined condition may be a value according to injury risk information equal to or greater than a reference level or the evacuation of at least one occupant to a medical institution. For example, when a predetermined condition is based on injury risk information, if an AIS code, which is an injury level exemplified in FIG. 3A, is equal to or greater than 3, personalized injury risk information may be externally notified, and the processor 170 may request an emergency evacuation to a server of a medical institution. When some of a plurality of occupants have injury risk information with a reference level or above, the processor 170 may externally notify an occupant's injury risk information that reaches or exceeds the reference level. As another example, when some of a plurality of occupants have injury risk information with a reference level or above, the processor 170 may also externally notify an occupant's injury risk information that does not reach the reference level. Accordingly, as an external medical institution treats an occupant with the reference level or above, it can check a difference between an occupant's injury risk information not reaching the reference level and an actual injury level. If the actual injury level is different from the notified injury risk information, the server of the medical institution may transmit actual injury data or medical data to the processor 170.

Next, the processor 170 may receive medical data generated from the external treatment of the occupant, recalculate injury risk information based on the medical data, and update the safety control model (or learning model) managed by the memory 160 (S150).

In addition, when an occupant not reaching the reference level is evacuated and an actual injury level is different from notified injury risk information, medical data may be transmitted as described above. Based on the medical data, the processor 170 may check erroneous injury risk information, update a safety control model, and recalculate the occupant's injury risk information.

According to the present disclosure, it is possible to provide a personalized active safety control method and device that actively restrain an occupant in an optimal manner according to the occupant's body profile and a real-time occupancy state and thus enhance safety function in case of a collision accident of a vehicle.

Specifically, by using an AI-based collision optimization model that is trained with the conditions and results of a crash test performed in various modes, an active control technology for a restraint device may be implemented based on various factors like an occupant's body condition and an occupancy state in an actual collision situation of a vehicle, so that the occupant's injury may be minimized.

According to the present disclosure, information on an occupant's own injury risk, which is estimated in an actual collision situation, may be delivered to an emergency system through an urgency notification system of a vehicle, and the occupant's accurate injury state may be provided to a medical institution. In addition, after a treatment, the occupant's medical data is provided to the collision optimization model as feedback, and thus the model and personalized injury risk information may be updated more suitably for the occupant.

Effects obtained in the present disclosure are not limited to the above-mentioned effects, and other effects not mentioned above may be clearly understood by those skilled in the art from the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for personalized active safety control, the method comprising:
generating input data including body information of an occupant of a vehicle and occupancy state information of the occupant;
outputting initial control data of a restraint device of the vehicle based on collision data in response to a collision of the vehicle;
producing injury risk information for each piece of adjustment restraint information by using a safety control model based on the adjustment restraint information, wherein a variable adjustment parameter is applied to the initial control data and the input data;
generating, by the safety control model, optimal restraint control information from among the adjustment restraint information based on the injury risk information; and
controlling the restraint device based on the optimal restraint control information.

2. The method of claim 1, wherein the input data includes the body information, the occupancy state information and the collision data, and
wherein the safety control model is established as a model that is learned to: (a) produce part injury data for each body part of an occupant based on the input data and the adjustment restraint information, and (b) generate an estimated injury degree based on the part injury data.

3. The method of claim 2, wherein the estimated injury degree is generated by adjusting a basic estimated injury degree based on the part injury data, and
wherein the basic estimated injury degree is set in advance based on the collision data and the body information.

4. The method of claim 3, wherein the body information includes the occupant's age, height, weight, and sex, and
wherein the basic estimated injury degree is individually set according to a section of the age.

5. The method of claim 1, wherein the collision data is converted into general collision data that is input to the initial control data.

6. The method of claim 1, wherein the generating of the input data step further comprises:
estimating the detailed body information that is not received, based on data obtained through a camera of an occupant monitoring module and an occupant information estimation module of the vehicle, if at least a portion of the detailed body information constituting the body information is not received as an input of the occupant, and
generating the body information by using the estimated detailed body information.

7. The method of claim 1, wherein the occupancy state information includes the occupant's sitting posture in a seat and a relative spacing state between the occupant's body part and an interior part of the vehicle.

8. The method of claim 7, wherein the occupancy state information is generated based on image data that is obtained from a camera of an occupant monitoring module installed in the vehicle.

9. The method of claim 7, wherein the sitting posture of the occupant is estimated based on the body condition.

10. The method of claim 1, further comprising:
setting the injury risk information associated with the optimal restraint control information as personalized injury risk information;
notifying, externally, the injury risk information in response to satisfaction of a predetermined condition;
receiving medical data caused by external treatment of an injured occupant; and
recalculating the injury risk information based on the medical data and updating the safety control model.

11. A device for personalized active safety control, the device comprising:
a memory storage configured to manage a learning model; and
a processor configured to process active safety control by using a safety control model according to the learning model,
wherein the processor is further configured to:
generate input data including body information of an occupant of a vehicle and occupancy state information of the occupant,
output initial control data of a restraint device of the vehicle based on collision data in response to a collision of the vehicle,
produce injury risk information for each piece of adjustment restraint information by using the safety control model based on the adjustment restraint information, wherein a variable adjustment parameter is applied to the initial control data and the input data;
generate, by the safety control model, optimal restraint control information from among the adjustment restraint information based on the injury risk information, and
control the restraint device based on the optimal restraint control information.

12. The device of claim 11, wherein the input data includes the body information, the occupancy state information and the collision data, and
wherein the safety control model is constructed as a model that is learned to: (a) produce part injury data for each body part of an occupant based on the input data and the adjustment restraint information, and (b) generate an estimated injury degree based on the part injury data.

13. The device of claim 12, wherein the estimated injury degree is generated by adjusting a basic estimated injury degree based on the part injury data, and
wherein the basic estimated injury degree is set in advance based on the collision data and the body information.

14. The device of claim 13, wherein the body information includes the occupant's age, height, weight, and sex, and
wherein the basic estimated injury degree is individually set according to a section of the age.

15. The device of claim 11, wherein the collision data is converted into general collision data that is input to the initial control data.

16. The device of claim 11, wherein to generate the input data the processor is further configured to:
estimate the detailed body information that is not received, based on data obtained through a camera of an occupant monitoring module and an occupant information estimation module of the vehicle, if at least a portion of the detailed body information constituting the body information is not received as an input of the occupant, and
generate the body information by using the estimated detailed body information.

17. The device of claim 11, wherein the occupancy state information includes the occupant's sitting posture in a seat and a relative spacing state between the occupant's body part and an interior part of the vehicle.

18. The device of claim 17, wherein the occupancy state information is generated based on image data that is obtained from a camera of an occupant monitoring module installed in the vehicle.

19. The device of claim 17, wherein the sitting posture of the occupant is estimated based on the body condition.

20. The device of claim 11, wherein the processor is further configured to:
set the injury risk information associated with the optimal restraint control information as personalized injury risk information;
notify, externally, the injury risk information in response to satisfaction of a predetermined condition;
receive medical data caused by external treatment of an injured occupant; and
recalculate the injury risk information based on the medical data and update the safety control model.
